(19) United States
(12) Patent Application Publication
(10) Pub. No.: US 2026/0014465 A1
(43) Pub. Date: Jan. 15, 2026

(54) VIRTUAL ARTICLE PROCESSING

(71) Applicant: Tencent Technology (Shenzhen) Company Limited, Shenzhen (CN)

(72) Inventors: Yinglei WANG, Shenzhen (CN); Jiaqi PAN, Shenzhen (CN)

(73) Assignee: Tencent Technology (Shenzhen) Company Limited, Shenzhen (CN)

(21) Appl. No.: 19/330,189

(22) Filed: Sep. 16, 2025

Related U.S. Application Data
(63) Continuation of application No. PCT/CN2024/103389, filed on Jul. 3, 2024.

(30) Foreign Application Priority Data
Sep. 1, 2023 (CN) 202311138477.1

(51) Int. Cl. A63F 13/533; A63F 13/55

(52) U.S. Cl. CPC A63F 13/533; A63F 13/55

(57) ABSTRACT

In a virtual object processing method, a construction interface of a virtual building is output for display in a virtual scene. The virtual building includes at least one virtual object. At least one recommended virtual object is output for display based on a trigger operation performed on a reference virtual object of the at least one virtual object of the virtual building. The at least one recommended virtual object is determined based on a recommendation label of the reference virtual object. Based on a selection operation performed on a target virtual object of the at least one recommended virtual object, the target virtual object is added to the virtual building.

### RELATED APPLICATIONS

The present application is a continuation of International Application No. PCT/CN2024/103389, filed on Jul. 3, 2024, which claims priority to Chinese Patent Application No. 202311138477.1, filed on Sep. 1, 2023. The entire disclosures of the prior applications are hereby incorporated by reference.

### FIELD OF THE TECHNOLOGY

This application relates to human-computer interaction technologies, including a virtual article processing.

### BACKGROUND OF THE DISCLOSURE

A display technology based on graphics processing hardware expands channels for environmental perception and information acquisition. For example, a virtual scenario display technology can implement, based on an actual application requirement, diversified interaction between virtual objects that are controlled by users or artificial intelligence, and has various typical application scenarios. For example, in a virtual scenario of a constructive game, an actual construction process of virtual buildings or virtual homes can be simulated.

In a process in which a target account (player) controls a virtual character to construct a virtual building in a virtual scenario, if a virtual article in a virtual building that is being constructed currently needs to be replaced, a to-be-replaced virtual article usually needs to be first selected, the to-be-replaced virtual article is stowed into a warehouse through a “retrieve” or “delete” button, then a new virtual article that the player intends to arrange is selected from the warehouse, and the new virtual article is arranged in the virtual building through a “place” button, to replace the to-be-replaced virtual article.

However, in an actual application, articles in an article list on a construction interface of a construction game are in a large quantity and a rich variety. If the user intends to find a particular new virtual article, the user needs to perform screening level by level. For example, the user first finds out first-level and second-level tabs corresponding to the new virtual article, and then selects, from the tabs, a new virtual article that the user intends to newly arrange. This has problems of low browsing, searching, and screening efficiency, resulting in low efficiency of replacing a virtual article.

### SUMMARY

Aspects of this disclosure provide a virtual article processing method, a virtual article processing apparatus, and a non-transitory computer-readable storage medium to improve efficiency of constructing a virtual building.

Examples of technical solutions of this disclosure may be implemented as follows:

An aspect of this disclosure provides a virtual object processing method. In the method, a construction interface of a virtual building is output for display in a virtual scene. The virtual building includes at least one virtual object. At least one recommended virtual object is output for display based on a trigger operation performed on a reference virtual object of the at least one virtual object of the virtual building. The at least one recommended virtual object is determined based on a recommendation label of the reference virtual object. Based on a selection operation performed on a target virtual object of the at least one recommended virtual object, the target virtual object is added to the virtual building.

An aspect of this disclosure provides a virtual object processing apparatus. The apparatus includes processing circuitry configured to output for display a construction interface of a virtual building in a virtual scene. The virtual building includes at least one virtual object. The processing circuitry is configured to output for display at least one recommended virtual object based on a trigger operation performed on a reference virtual object of the at least one virtual object of the virtual building. The at least one recommended virtual object is determined based on a recommendation label of the reference virtual object. The processing circuitry is configured to add, based on a selection operation performed on a target virtual object of the at least one recommended virtual object, the target virtual object to the virtual building.

An aspect of this disclosure provides a virtual article processing method, including: displaying a virtual building on a construction interface of a virtual scenario, the virtual building including at least one virtual article; displaying, in response to a trigger operation on a target virtual article, at least one recommendation virtual article, the recommendation virtual article corresponding to a recommendation label of the target virtual article; and placing a target recommendation article in the virtual building in response to a selection operation on the target recommendation article.

An aspect of this disclosure provides a virtual article processing apparatus, including: a first display module, configured to display a virtual building on a construction interface of a virtual scenario, the virtual building including at least one virtual article; a second display module, configured to display, in response to a trigger operation on a target virtual article, at least one recommendation virtual article, the recommendation virtual article corresponding to a recommendation label of the target virtual article; and an article placement module, configured to place a target recommendation article in the virtual building in response to a selection operation on the target recommendation article.

An aspect of this disclosure provides an electronic device, including: a memory, configured to store computer-executable instructions or a computer program; and a processor, configured to implement, when executing the computer-executable instructions or the computer program stored in the memory, the virtual article processing method provided in the aspects of this disclosure.

An aspect of this disclosure provides a non-transitory computer-readable storage medium storing instructions which, when executed by a processor, cause the processor to implement the virtual article processing method provided in the aspects of this disclosure.

An aspect of this disclosure provides a computer program product, including a computer program or computer-executable instructions. The computer program or the computer-executable instructions, when executed by a processor, implement the virtual article processing method provided in the aspects of this disclosure.

The aspects of this disclosure have the following beneficial effects:

According to the aspects of this disclosure, during construction of a virtual building, when a player intends to replace or newly place a virtual article in the virtual building, if a target virtual article in the virtual building is triggered, one or more selectable recommendation virtual articles are displayed on a construction interface. The player may select a target recommendation article therefrom and place the target recommendation article in the virtual building, to replace the target virtual article in the virtual building, or newly create the target recommendation article in the virtual building. In this way, the player can select the needed target recommendation article in the recommendation virtual article without screening level by level. Compared with the related art, an operation path for replacing or newly placing a virtual article is greatly shortened, operations are simplified, and operation efficiency is improved. In addition, the recommendation virtual article corresponds to a recommendation label of the target virtual article, that is, the recommendation virtual article is recommended based on the recommendation label of the target virtual article. Therefore, pertinence and accuracy of virtual article recommendation can be improved, and the player can select a satisfying target recommendation article to construct the virtual building, thereby improving efficiency of constructing the virtual building.

### BRIEF DESCRIPTION OF THE DRAWINGS

FIG. 1 is a schematic diagram of an architecture of a virtual article processing system 100 according to an aspect of this disclosure.

FIG. 2 is a schematic structural diagram of an electronic device 500 according to an aspect of this disclosure.

FIG. 3 is a schematic flowchart of a virtual article processing method according to an aspect of this disclosure.

FIG. 4 is a schematic diagram of displaying a recommendation virtual article according to an aspect of this disclosure.

FIG. 5 is a schematic diagram of arranging a virtual article according to an aspect of this disclosure.

FIG. 6 is a schematic diagram of placing a virtual article according to an aspect of this disclosure.

FIG. 7 is a schematic diagram of details of virtual articles according to an aspect of this disclosure.

FIG. 8 is a schematic diagram of settings of virtual articles according to an aspect of this disclosure.

FIG. 9 is a schematic flowchart of a virtual article processing method according to an aspect of this disclosure.

FIG. 10 is a schematic flowchart of a virtual article recognition method according to an aspect of this disclosure.

FIG. 11A and FIG. 11B are schematic diagrams of displaying a trigger manner according to an aspect of this disclosure.

FIG. 12A and FIG. 12B are schematic diagrams of recognizing a virtual article according to an aspect of this disclosure.

### DETAILED DESCRIPTION

To make the objectives, technical solutions, and advantages of this disclosure clearer, the following describes this disclosure in further detail with reference to the accompanying drawings. The described aspects are not to be considered as a limitation to this disclosure. Other aspects shall fall within the scope of this disclosure. The descriptions of the terms are provided as examples only and are not intended to limit the scope of the disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In the following descriptions, “some aspects” describe a subset of all possible aspects. However, the “some aspects” may be the same subset or different subsets of all the possible aspects, and may be combined with each other without conflict.

In the following descriptions, the term “first/second . . . ” involved is merely configured for distinguishing between similar objects and does not represent a specific order of objects. “first/second . . . ” may be transposed for a specific order or a sequence when allowed, so that the aspects of this disclosure described herein can be implemented in an order other than those illustrated or described herein.

Unless otherwise defined, meanings of all technical and scientific terms used herein are the same as those usually understood by those skilled in the art to which this disclosure belongs. The examples of terms used herein are merely intended to describe the objectives of the aspects of this disclosure, and are not intended to limit this disclosure.

Before the aspects of this disclosure are further described in detail, terms involved in the aspects of this disclosure are described, and the following explanations are applicable to the terms involved in the aspects of this disclosure.

(1) A client is an application that is run on a terminal to provide various services, for example, a video play client or a game client.

(2) “In response to” is configured for representing a condition or a status on which an executed operation depends, and when the dependent condition or status is met, one or more executed operations may be in real time or may have a set delay.

(3) A virtual scenario is a virtual scenario displayed (or provided) when an application is run on a terminal. The virtual scenario may be a simulated environment of the real world, may be a semi-simulated and semi-fictional virtual environment, or may be a purely fictional virtual environment. The virtual scenario may be any one of a two-dimensional virtual scenario, a 2.5-dimensional virtual scenario, or a three-dimensional virtual scenario. A dimension of the virtual scenario is not limited in the aspects of this disclosure. For example, the virtual scenario may include the sky, the land, the ocean, and the like. The land may include an environment element like a desert or a city, and a user may control a virtual object to move in the virtual scenario.

(4) A virtual building is a building constructed by a player in a virtual scenario, for example, a virtual building for architecture like a house, a wall, or a garden, a virtual building for transportation like a bridge, a road, a ship, or a plane; or certainly, may be another type of building. The virtual building may have a shape and a volume of the virtual building in the virtual scenario, occupying a part of space in the virtual scenario. The player may construct or build a virtual building by using virtual articles or virtual components. In other words, each virtual building includes a plurality of virtual articles or virtual components.

The aspects of this disclosure provide a virtual article processing method and apparatus, an electronic device, a computer-readable storage medium, and a computer program product, to improve efficiency of constructing a virtual building. The following describes an example application of an electronic device provided in an aspect of this disclosure. The electronic device provided in this aspect of this disclosure may be implemented as various types of user terminals such as a laptop computer, a tablet computer, a desktop computer, a set-top box, and a mobile device (for example, a mobile phone, a portable music player, a personal digital assistant, a dedicated messaging device, or a portable gaming device), a smartphone, a smart speaker, a smartwatch, a smart television, and an in-vehicle terminal, or may be implemented as a server. Example applications are described below by using examples in which the electronic device is implemented as a terminal.

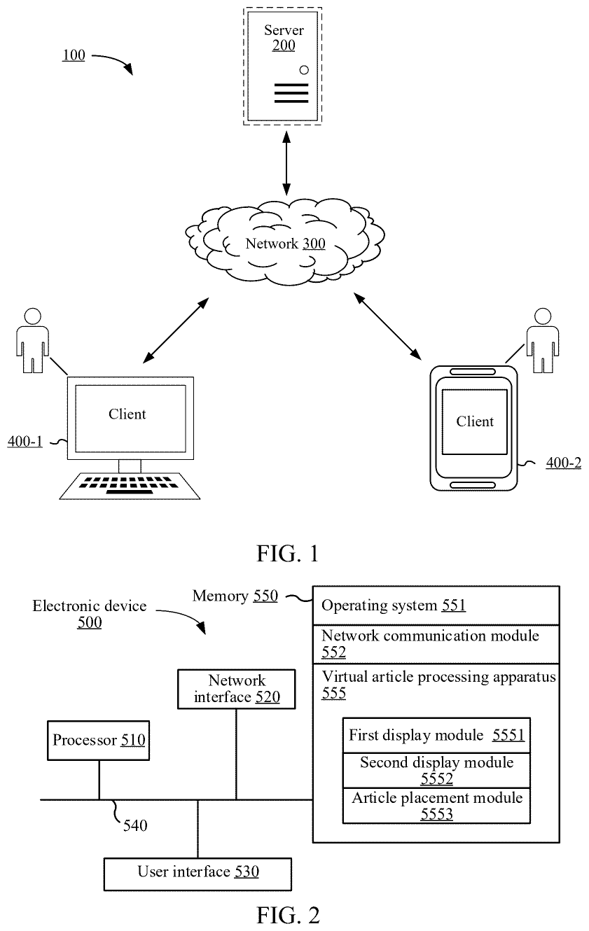

FIG. 1 is a schematic diagram of an architecture of a virtual article processing system 100 according to an aspect of this disclosure. To support an example application, terminals (a terminal 400-1 and a terminal 400-2 are shown as examples) are connected to a server 200 through a network 300. The network 300 may be a wide area network, a local area network, or a combination thereof.

In some aspects, the terminal is provided with a client, such as a video playing client, an instant messaging client, a game client, or a live streaming client. The server 200 is a background server corresponding to the client, which may be an independent physical server, may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal and the server may be directly or indirectly connected in a wired or wireless communication manner. This is not limited in the aspects of this disclosure.

In an actual application, the terminal displays a virtual building on a construction interface of a virtual scenario, the virtual building including at least one virtual article. The terminal generates and transmits a recommendation request to the server 200 in response to a trigger operation on a target virtual article. The server 200 obtains, based on the recommendation request, at least one recommendation virtual article corresponding to a recommendation label of the target virtual article, and returns the obtained at least one recommendation virtual article to the terminal. The terminal displays the at least one recommendation virtual article, and places a target recommendation article in the virtual building in response to a selection operation on the target recommendation article.

FIG. 2 is a schematic structural diagram of an electronic device 500 according to an aspect of this disclosure. Using an example in which the electronic device 500 is the terminal in FIG. 1, the electronic device 500 shown in FIG. 2 includes: processing circuitry (for example, at least one processor 510), a memory 550 (for example, a non-transitory computer-readable storage medium), at least one network interface 520, and a user interface 530. All components in the electronic device 500 are coupled together through a bus system 540. The bus system 540 is configured to implement connection and communication between the components. In addition to a data bus, the bus system 540 also includes a power supply bus, a control bus, and a status signal bus. However, for clarity, various buses are marked as the bus system 540 in FIG. 2.

Processing circuitry, such as the processor 510, may be an integrated circuit chip with a signal processing capability, for example, a general-purpose processor, a digital signal processor (DSP), another programmable logic device, a discrete gate or a transistor logic device, or a discrete hardware component. The general-purpose processor may be a microprocessor, any conventional processor, or the like.

The memory 550 includes a volatile memory or a non-volatile memory, or may include a volatile memory and a non-volatile memory. The non-volatile memory may be a read only memory (ROM), and the volatile memory may be a random access memory (RAM). The memory 550 described in this aspect of this disclosure is intended to include any suitable type of memory. In some aspects, the memory 550 includes one or more storage devices physically away from the processor 510.

In some aspects, the memory 550 can store data to support various operations. Examples of the data include a program, a module, and a data structure or a subset or a superset thereof. An example description is given below.

An operating system 551 includes system programs configured to process various basic system services and perform hardware-related tasks, for example, a frame layer, a core library layer, and a driver layer, to implement various basic services and process hardware-based tasks. A network communication module 552 is configured to reach another electronic device via one or more (wired or wireless) network interfaces 520. Example network interfaces 520 include: Bluetooth, Wi-Fi, a universal serial bus (USB), and the like.

In some aspects, the virtual article processing apparatus provided in the aspects of this disclosure may be implemented by using software. The virtual article processing apparatus provided in the aspects of this disclosure may be provided as various software aspects, including various forms such as an application, software, a software module, a script, or code. FIG. 2 shows a virtual article processing apparatus 555 stored in the memory 550. The apparatus may be software in a form of a program, a plug-in, or the like, and includes a series of modules, including a first display module 5551, a second display module 5552, and an article placement module 5553. The modules are logical, and therefore may be combined or further split based on implemented functions. Functions of the modules are described below.

In some other aspects, the apparatus provided in this aspect of this disclosure may be implemented in a hardware manner. In an example, the apparatus provided in this aspect of this disclosure may be a processor in the form of a hardware decoding processor, which is programmed to perform the virtual article processing method provided in the aspects of this disclosure. For example, the processor in the form of the hardware decoding processor may use one or more application specific integrated circuits (ASICs), digital signal processors (DSPs), programmable logic devices (PLDs), complex programmable logic devices (PLDs), complex programmable logic devices (CPLDs), field-programmable gate arrays (FPGAs), or other electronic elements.

In some aspects, the terminal or the server may implement the virtual article processing method provided in the aspects of this disclosure by running various computer-executable instructions or a computer program. For example, the computer-executable instructions may be microprogram-level commands, machine instructions, or software instructions. The computer program may be a native program or a software module in an operating system; may be a native application (APP), namely, a program that needs to be installed in an operating system to run, for example, an instant messaging APP or a live streaming APP; or may be a mini program that may be embedded in any APP, namely, a program that only needs to be downloaded into a browser environment to run. In conclusion, the foregoing computer-executable instructions may be instructions in any form, and the foregoing computer program may be an application, a module, or a plug-in in any form.

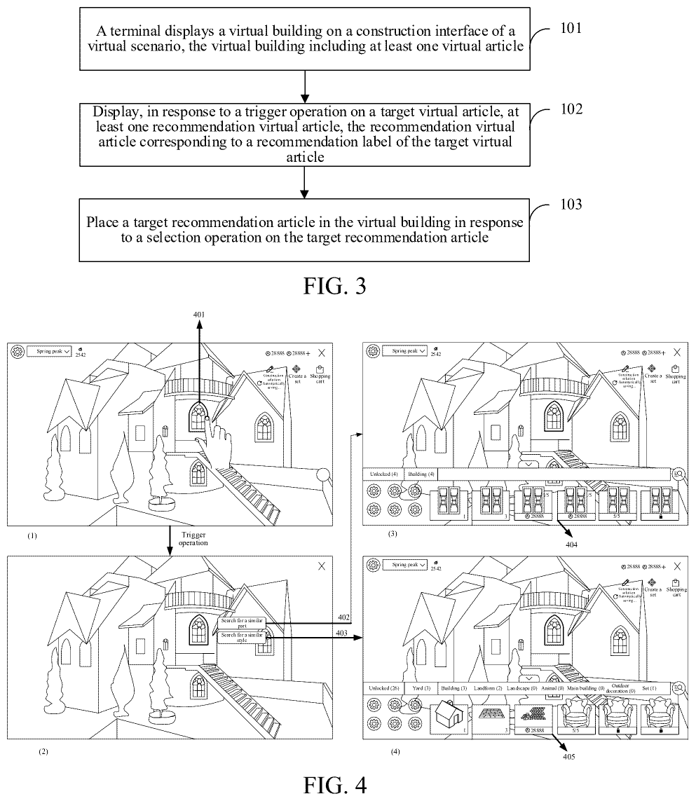

As described above, the virtual article processing method provided in the aspects of this disclosure may be implemented by various types of electronic devices, for example, may be independently performed by either of the terminal and the server 200 in FIG. 1, or may be cooperatively performed by the terminal and the server 200 in FIG. 1. Next, an example in which the terminal in FIG. 1 independently performs the virtual article processing method provided in the aspects of this disclosure is used for description. FIG. 3 is a schematic flowchart of a virtual article processing method according to an aspect of this disclosure. Descriptions are provided with reference to operations shown in FIG. 3.

Operation 101: A terminal displays a virtual building on a construction interface of a virtual scenario, the virtual building including at least one virtual article. For example, a construction interface of a virtual building is output for display in a virtual scene. The virtual building includes at least one virtual object.

In an actual application, a client supporting the virtual scenario is installed on the terminal (for example, when the virtual scenario is a game, the corresponding client may be a constructive game APP). When a user opens the client installed on the terminal and the terminal runs the client, a construction interface constructed by a target account (that is, an account corresponding to the current terminal) in the virtual scenario may be displayed on the client, and a virtual building is displayed on the construction interface. The virtual building includes at least one virtual article. For example, the virtual building is a house. In this case, the virtual article may be a component like a window, a door, a wall, a roof, a floor, or furniture (such as a desk, a chair, a table light, a bed, or a sofa) in the house. The virtual articles are configured for constructing the virtual building like the house, and are components of the virtual building.

Operation 102: Display, in response to a trigger operation on a target virtual article, at least one recommendation virtual article, the recommendation virtual article corresponding to a recommendation label of the target virtual article. For example, at least one recommended virtual object is output for display based on a trigger operation performed on a reference virtual object of the at least one virtual object of the virtual building. The at least one recommended virtual object is determined based on a recommendation label of the reference virtual object.

In an actual application, when a player intends to replace or edit a virtual article in the virtual building or intends to newly place a virtual article, this may be implemented by triggering an existing virtual article in the virtual building. For example, when the player triggers the target virtual article, the terminal displays, in response to the trigger operation, the at least one recommendation virtual article corresponding to the recommendation label of the target virtual article, for the player to select a required recommendation virtual article in the at least one recommendation virtual article, to place the selected recommendation virtual article in the virtual building.

The recommendation label is configured for identifying a part, a style, or the like to which the recommendation virtual article belongs. For example, the part or the style corresponding to the displayed at least one recommendation virtual article corresponds to the part or the style indicated by the recommendation label of the target virtual article, that is, the recommendation virtual article is recommended based on the recommendation label of the target virtual article. In this way, pertinence and accuracy of virtual article recommendation can be improved, and the player can select a satisfying target recommendation article to construct a virtual building, thereby improving efficiency of constructing the virtual building.

In some aspects, before the at least one recommendation virtual article is displayed, the terminal may receive the trigger operation on the target virtual article in the following manner: performing, in response to a trigger operation on a target region in the virtual building, article recognition processing on an article projection carried in the target region, to obtain a first recognition result; using, when the first recognition result represents that the article projection carried in the target region is a projection of one virtual article, the virtual article corresponding to the article projection as a target virtual article; or recognizing, when the first recognition result represents that the article projection carried in the target region is projections of a plurality of virtual articles, integrity of the projections of the plurality of virtual articles in the target region, to obtain a second recognition result, and determining a target virtual article based on the second recognition result; and using the trigger operation on the target region as a trigger operation on the target virtual article.

The trigger operation may be an operation in a form like a single-tap operation, a long-press operation, or a circling operation, or certainly may be an operation in another form. A form of the trigger operation is not limited in the aspects of this disclosure. Using an example in which the player triggers the foregoing trigger operation by using a finger, the target region is a contact region (for example, when the trigger operation is the long-press operation, the target region is a region long-pressed by the finger) or a circled region (for example, when the trigger operation is the circling operation, the target region is a circled region by the finger) by the finger on the virtual building when the player triggers the foregoing trigger operation on the virtual building.

When the terminal receives the trigger operation of the player on the target region, the terminal performs article recognition processing on the article projection carried in the target region, to determine a corresponding virtual article in the target region based on the first recognition result obtained through recognition. For example, the first recognition result is configured for indicating whether the article projection carried in the target region is a projection of one virtual article. For example, when the first recognition result represents that the article projection carried in the target region is the projection of one virtual article (that is, the article projection is the projection of one virtual article in the target region), it may be determined that the virtual article in the target region is the virtual article corresponding to the projection, and the virtual article is used as the target virtual article. When the first recognition result represents that the article projection carried in the target region is projections of a plurality of (two or more) virtual articles, integrity of the projections of the plurality of virtual articles in the target region is further recognized, and the target virtual article is determined based on the second recognition result obtained through recognition. In other words, when the first recognition result represents that the article projection carried in the target region is the projections of the plurality of virtual articles, the second recognition result is configured for indicating whether the projections of the plurality of virtual articles in the target region are complete. After the target virtual article is determined, the trigger operation on the target region in the virtual building may also be considered as the trigger operation on the target virtual article in the virtual building.

In some aspects, the terminal may determine the target virtual article based on the second recognition result in the following manner: obtaining a projection area of each of the virtual articles in the target region when the second recognition result represents that the projections of the plurality of virtual articles in the target region each are incomplete, and using a virtual article having a largest projection area as the target virtual article; or when the second recognition result represents that projections of a first quantity of virtual articles in the plurality of virtual articles are complete and projections of a second quantity of virtual articles are incomplete, determining the target virtual article based on the first quantity of virtual articles.

When the second recognition result represents that the projections of the plurality of virtual articles in the target region each are incomplete, the target virtual article is determined based on the projection area of each of the virtual articles in the target region. For example, when the first recognition result represents that three virtual articles, namely, a virtual article 1, a virtual article 2, and a virtual article 3, have projections in the target region, integrity of the projections of the three virtual articles, namely, the virtual article 1, the virtual article 2, and the virtual article 3 in the target region is further recognized. When the second recognition result represents that the projections of the virtual article 1, the virtual article 2, and the virtual article 3 in the target region each are incomplete, projection areas of the virtual article 1, the virtual article 2, and the virtual article 3 in the target region are further obtained, and a virtual article having a largest projection area is selected as the target virtual article. For example, if the projection area of the virtual article 1 is larger than the projection area of the virtual article 2, and the projection area of the virtual article 2 is larger than the projection area of the virtual article 3, the virtual article 1 may be used as the target virtual article.

When the second recognition result represents that the projections of the plurality of virtual articles (that is, the virtual articles having projections in the target region) corresponding to the article projection in the target region each are complete in the target region, or when projections of some of the virtual articles (for example, the first quantity of virtual articles) are complete and projections of some of the virtual articles (for example, the second quantity of virtual articles) are incomplete, the target virtual article is further determined based on the virtual articles with complete projections.

In some aspects, the terminal may determine the target virtual article based on the first quantity of virtual articles in the following manner: using, when the first quantity is 1, the virtual article with the complete projection as the target virtual article; or obtaining, when the first quantity is greater than 1, a distance between each of the virtual articles in the first quantity of virtual articles and a camera, and using a virtual article having a shortest distance as the target virtual article.

When the second recognition result represents that the projections of the plurality of virtual articles corresponding to the article projection in the target region each are complete in the target region or projections of some of the virtual articles are complete, the target virtual article is further determined based on the virtual articles with complete projections. When one virtual article with a complete projection is provided, the virtual article with the complete projection may be used as the target virtual article. When a plurality of (greater than or equal to two) virtual articles with complete projections are provided, a distance between each of the virtual article with the complete projections and the camera (where the camera is a camera configured to obtain the current construction interface in the virtual scenario) is further obtained. For example, when the virtual articles with the complete projections include a virtual article 1, a virtual article 2, and a virtual article 3, a distance between each of the virtual article 1, the virtual article 2, and the virtual article 3 and the camera is obtained, and a virtual article having a shortest distance is used as the target virtual article. For example, if the distance between the virtual article 1 and the camera is less than the distance between the virtual article 2 and the camera, and the distance between the virtual article 2 and the camera is less than the distance between the virtual article 3 and the camera, the virtual article 1 is used as the target virtual article.

After the target virtual article corresponding to the target region is determined, the trigger operation on the target region may be considered as the trigger operation on the target virtual article, and the terminal may display, in response to the trigger operation, the at least one recommendation virtual article corresponding to the recommendation label of the target virtual article, for selection by the player.

In some aspects, the terminal may display the at least one recommendation virtual article in the following manner: displaying at least one selectable recommendation label; and displaying, in response to a label selection operation, at least one recommendation virtual article corresponding to a selected recommendation label.

The terminal displays, in response to the trigger operation on the target virtual article, one or more (two or more) selectable recommendation labels, for example, labels for recommending a similar part or recommending a similar style. After the player selects a recommendation label, the terminal displays, in response to the selection operation, a recommendation virtual article corresponding to the selected recommendation label, for selection and use by the player.

In some aspects, the terminal may display the at least one recommendation virtual article corresponding to the selected recommendation label in the following manner: displaying, when the selected recommendation label indicates to recommend a virtual article corresponding to a part to which the target virtual article belongs, at least one recommendation virtual article corresponding to the part; or displaying at least one recommendation virtual article corresponding to a target style when the selected recommendation label indicates to recommend a virtual article corresponding to a construction style of the target virtual article.

When the selected recommendation label indicates to recommend the virtual article corresponding to the part to which the target virtual article belongs, the at least one recommendation virtual article corresponding to the part is displayed. For example, when the part to which the target virtual article belongs is a window, a plurality of selectable windows are displayed as recommendation virtual articles. For another example, when the part to which the target virtual article belongs is a roof, a plurality of selectable roofs are displayed as recommendation virtual articles. When the selected recommendation label indicates to recommend the virtual article corresponding to the construction style of the target virtual article, the recommendation virtual article corresponding to the target style is displayed. The target style includes at least one of the construction style corresponding to the target virtual article or an association style associated with the construction style corresponding to the target virtual article. For example, the construction style of the target virtual article is a pastoral style, and an association style associated with the pastoral style may be a fresh style, a simple style, or the like. In this case, the target style may be at least one of the pastoral style, the fresh style, and the simple style, and a recommendation virtual article corresponding to at least one of the pastoral style, the fresh style, and the simple style may be displayed.

FIG. 4 is a schematic diagram of displaying a recommendation virtual article according to an aspect of this disclosure. In response to a trigger operation on a target virtual article 401 (where a part to which the target virtual article belongs is a window) in (1), the terminal displays two selectable recommendation labels in (2), including a part label (for example, for searching for a similar part) 402 and a style label (for example, for searching for a similar style) 403. The part label 402 is configured for indicating to search for or recommend a recommendation virtual article corresponding to the part (that is, the window) to which the target virtual article 401 belongs, and the style label 403 is configured for indicating to search for or recommend a recommendation virtual article corresponding to a construction style (for example, a pastoral style) of the target virtual article. When the player selects the part label 402, the terminal displays, in response to the selection operation, recommendation virtual articles 404 corresponding to the part “window” in (3). When the player selects the style label 403, the terminal displays, in response to the selection operation, recommendation virtual articles 405 (such as a roof, a wall, and a chair) corresponding to a same or similar style (for example, a European style) as a construction style “royal style” in (4).

In the foregoing manner, the recommendation virtual article is recommended based on the recommendation label of the target virtual article. In this way, pertinence and accuracy of virtual article recommendation can be improved, and the player can select a satisfying target recommendation article to construct a virtual building, thereby improving the efficiency of constructing the virtual building.

In some aspects, the terminal may display the at least one recommendation virtual article corresponding to the target style in the following manner: determining, when a plurality of types of the target style are provided, an association degree between each type of the target style and the construction style; and sequentially displaying the at least one recommendation virtual article corresponding to the target style in descending order of association degrees.

When the plurality of types of the target style are provided, the association degree between each target style and the construction style corresponding to the target virtual article may be determined. Usually, the closer the target style is to the construction style corresponding to the target virtual article, the larger the association degree between the target style and the construction style corresponding to the target virtual article. It is assumed that the construction style corresponding to the target virtual article is the pastoral style, and the target style includes the pastoral style, the fresh style, and the simple style. In this case, when the target style is the pastoral style, the association degree between the target style and the construction style corresponding to the target virtual article is 100 (where it is assumed that the association degree is 100 at the highest); when the target style is the fresh style, the association degree between the target style and the construction style corresponding to the target virtual article is 90; and when the target style is the simple style, the association degree between the target style and the construction style corresponding to the target virtual article is 80. In this case, the at least one recommendation virtual article corresponding to the target style is sequentially displayed in descending order of association degrees. For example, a recommendation virtual article corresponding to the “pastoral style” is displayed before a recommendation virtual article corresponding to the “fresh style”, and the recommendation virtual article corresponding to the “fresh style” is displayed before a recommendation virtual article corresponding to the “simple style”. In this way, the player can quickly select a recommendation virtual article whose style is closest to the style of the target virtual article, to improve efficiency of selecting a virtual article, thereby facilitating improvement of the efficiency of constructing a virtual building.

In some aspects, before the at least one recommendation virtual article is displayed, the terminal may determine the recommendation label of each virtual article in the virtual building in the following manner: displaying an article configuration interface of the virtual building, and displaying a part setting control, a style setting control, and a style association control on the article configuration interface; setting, in response to a part setting operation triggered based on the part setting control, a part to which the at least one virtual article in the virtual building belongs; setting, in response to a style setting operation triggered based on the style setting control, a construction style corresponding to the virtual building or the at least one virtual article in the virtual building; setting, in response to a style association operation triggered based on a style association control, an association degree between different construction styles, to obtain an association style corresponding to the construction style; and determining a recommendation label of the virtual article based on at least one of the part, the construction style, and the association style.

In an actual application, a developer of the virtual scenario may preset a part (or a type), a construction style, an association style, and the like to which a virtual article forming a virtual building belongs. For example, when the target virtual article is set, the part to which the target virtual article belongs is set by using the part setting control, the construction style corresponding to the target virtual article is set by using the style setting control, and the association style associated with the construction style of the target virtual article is set by using the style association control, for example, an association degree between the construction style of the target virtual article and another construction style is set. Usually, the larger the association degree, the more similar the construction styles. If the construction style corresponding to the target virtual article is the pastoral style, and other construction styles include the fresh style and a retro style, an association degree between the pastoral style and the fresh style may be set to 90, and an association degree between the pastoral style and the retro style may be set to 20. Another construction style whose association degree exceeds an association degree threshold (which may be set to, for example, 80 based on an actual requirement) may be used as the association style of the construction style of the target virtual article. For example, the fresh style is used as an association style of the pastoral style, and the retro style is not an association style of the pastoral style.

After the part, the construction style, and the association style of the target virtual article are set, the recommendation label of the target virtual article may be set based on at least one of the foregoing part, the construction style, and the association style. For example, the recommendation label may include a part label and a style label. When the player selects the part label (indicating to recommend the virtual article corresponding to the part to which the target virtual article belongs), the at least one recommendation virtual article corresponding to the part to which the target virtual article belongs is displayed. When the player selects the style label (indicating to recommend the virtual article corresponding to the construction style of the target virtual article), at least one recommendation virtual article corresponding to the construction style or the association style of the target virtual article is displayed.

In some aspects, the terminal may display the at least one recommendation virtual article in the following manner: displaying, when at least two recommendation virtual articles are provided, a first quantity of recommendation virtual articles in the at least two recommendation virtual articles in a first display pattern, and displaying a second quantity of recommendation virtual articles in a second display pattern, where the first display pattern is different from the second display pattern, the first display pattern is configured for indicating that the first quantity of recommendation virtual articles are in a selectable state, and the second display pattern is configured for indicating that the second quantity of recommendation virtual articles are in an unselectable state.

When a plurality of recommendation virtual articles are provided, the recommendation virtual articles may be displayed in different display patterns (for example, display orders, different display colors, different display brightness, or different display fonts) based on a different status of each of the recommendation virtual articles (for example, whether the recommendation virtual article can be selected or whether the recommendation virtual article is locked). For example, when the plurality of recommendation virtual articles are provided, a recommendation virtual article in the selectable state (that is, the recommendation virtual article is in an unlocked state, and can be selected to be placed in the virtual building) is displayed in highlight (that is, in the first display pattern), and a recommendation virtual article in the unselectable state (that is, the recommendation virtual article is in a locked state, and before being unlocked, the recommendation virtual article cannot be selected to be placed in the virtual building) is displayed in shade (that is, in the second display pattern). In this way, recommendation virtual articles in different statuses are distinguished, so that the player can select a selectable recommendation virtual article in the recommendation virtual articles to place in the virtual building, thereby facilitating improvement of efficiency of screening a virtual article and the efficiency of constructing the virtual building.

In some aspects, the terminal may display the at least one recommendation virtual article in the following manner: obtaining, when the at least two recommendation virtual articles are provided, an influence parameter configured for influencing a selection priority of each of the recommendation virtual articles, where the influence parameter includes at least one of the following: a part to which the recommendation virtual article belongs, and an association degree between a construction style corresponding to the recommendation virtual article and the construction style corresponding to the target virtual article; and determining, based on the influence parameter, the selection priority of each of the recommendation virtual articles, and displaying each of the recommendation virtual articles in a display manner corresponding to the selection priority.

When a plurality of recommendation virtual articles are provided, different recommendation virtual articles may correspond to different selection priorities, and the recommendation virtual articles may be displayed in corresponding display patterns based on the selection priorities corresponding to the recommendation virtual articles. For example, a recommendation virtual article with a high selection priority is displayed in highlight. For example, three selectable recommendation virtual articles, namely, a recommendation virtual article 1, a recommendation virtual article 2, and a recommendation virtual article 3 are provided. Selection priorities corresponding to the three recommendation virtual articles sequentially decrease. The recommendation virtual article 1 may be displayed in a red font, the recommendation virtual article 2 may be displayed in a yellow font, and the recommendation virtual article 3 may be displayed in a gray font. In this way, a user can select a required recommendation virtual article, thereby facilitating improvement of the efficiency of screening the virtual article and the efficiency of constructing a virtual building.

When the selection priorities corresponding to the recommendation virtual articles are determined, a selection priority of a recommendation virtual article may be determined based on whether a part to which the recommendation virtual article belongs is consistent with the part to which the target virtual article belongs, or the selection priority of the recommendation virtual article may be determined based on an association degree between a construction style corresponding to the recommendation virtual article and the construction style corresponding to the target virtual article. Usually, the more the part to which the recommendation virtual article belongs is consistent with the part to which the target virtual article belongs (for example, a feature of the part to which the recommendation virtual article belongs and a feature of the part to which the target virtual article belongs may be extracted, a similarity between the features of the parts is calculated, and whether the part to which the recommendation virtual article belongs is consistent with the part to which the target virtual article belongs is determined by using a similarity value, where the higher the similarity, the higher the possibility that the part to which the recommendation virtual article belongs is consistent with the part to which the target virtual article belongs), the higher the selection priority corresponding to the recommendation virtual article, the larger the association degree between the construction style corresponding to the recommendation virtual article and the construction style corresponding to the target virtual article (for the association degree, a style feature of the construction style corresponding to the recommendation virtual article and a style feature of the construction style corresponding to the target virtual article may be extracted, a similarity between the style features are calculated, and the association degree is represented by using a similarity value, where the similarity value is positively correlated with the association degree, that is, the larger the similarity value, the larger the association degree), and the higher the selection priority corresponding to the recommendation virtual article. After the influence parameter configured for influencing the selection priority of each of the recommendation virtual articles is obtained, the influence parameter may be inputted to a trained neural network model for prediction processing, to obtain the selection priority of the recommendation virtual article, so that prediction can be more accurate.

Before the neural network model is applied, an initial neural network model needs to be trained, and then the trained neural network model is putted into application, to implement prediction on the selection priority of the recommendation virtual article by using an artificial intelligence technology with reference to the influence parameter. The neural network model is obtained through training by using a recommendation virtual article sample, an influence parameter corresponding to the recommendation virtual article sample, and selection priority labeled for the recommendation virtual article sample. For example, the initial neural network model is invoked to perform prediction processing based on the recommendation virtual article sample, a part to which the recommendation virtual article sample belongs, and the selection priority labeled for the recommendation virtual article sample, to obtain a predicted selection priority. After a value of a loss function of the neural network model is determined by using the predicted selection priority and the labeled selection priority, whether the value of the loss function exceeds a preset threshold can be determined. When the value of the loss function exceeds the preset threshold, an error signal of the neural network model is determined based on the loss function, the error signal is back-propagated in the neural network model, and a model parameter of each layer is updated during the propagation.

A model structure of the neural network model is not limited in the aspects of this disclosure. For example, the neural network model may be a convolutional neural network or a deep neural network. A form of the loss function is also not limited. For example, the loss function may be a cross-entropy loss function or an L2 loss function.

The back propagation is described. Training sample data is inputted to an input layer of the neural network model, passes through a hidden layer, and finally reaches an output layer, and then a result is outputted. This is a forward propagation process of the neural network model. Because there is an error between the output result and an actual result of the neural network model, the error between the output result and an actual value is calculated, and the error is back-propagated from the output layer to the hidden layer until the error is propagated to the input layer. During the back propagation, a value of a model parameter is adjusted based on the error, that is, the loss function is constructed based on the error between the output result and the actual value, and a partial derivative of the loss function for the model parameter is solved layer by layer, to generate a gradient of the loss function for the model parameter of each layer. Because a direction of the gradient represents a direction of error expansion, the gradient of the model parameter is inverted, and is summed up with an original mode parameter of each layer. An obtained summation result is used as an updated model parameter of each layer, to reduce the error caused by the model parameter. The foregoing process is continuously iterated until convergence is performed.

In an actual application, when the player selects the style label corresponding to the target virtual article, the terminal displays, in response to the selection operation, the recommendation virtual article corresponding to the target style. If a plurality of types of the target style are provided, the terminal determines an association degree between each type of the target style and the construction style of the target virtual article, and sequentially displays recommendation virtual articles corresponding to the target style in descending order of association degrees. If a plurality of recommendation virtual articles are provided for a target style, selection priorities of the plurality of recommendation virtual articles may be further determined from another dimension, and the corresponding recommendation virtual articles are displayed in a display order corresponding to the selection priorities. For example, a corresponding selection priority is determined based on a similarity between a part to which each recommendation virtual article belongs and the part to which the target virtual article belongs. For example, the higher similarity, the higher the corresponding selection priority; and the higher the selection priority, the higher the rank in the display order of the corresponding recommendation virtual article.

For example, if the part to which the target virtual article belongs is the “window” and the corresponding construction style is the “pastoral style”, when the player selects the style label of the target virtual article, the terminal determines, in response to the selection operation, that the target style includes the pastoral style, the fresh style, and the simple style. An association degree between the pastoral style and the pastoral style is greater than an association degree between the pastoral style and the fresh style, and the association degree between the pastoral style and the fresh style is greater than an association degree between the pastoral style and the simple style, that is, selection priorities of recommendation virtual articles corresponding to the pastoral style, the fresh style, and the simple style sequentially decrease. Therefore, the recommendation virtual articles corresponding to the pastoral style, the fresh style, and the simple style are first sequentially displayed in descending order of the association degrees (that is, descending order of the selection priorities). For example, the recommendation virtual article corresponding to the “pastoral style” is displayed before the recommendation virtual article corresponding to the “fresh style”, and the recommendation virtual article corresponding to the “fresh style” is displayed before the recommendation virtual article corresponding to the “simple style”. When each target style corresponds to a plurality of recommendation virtual articles, an example in which the recommendation virtual article corresponding to the “pastoral style” includes a recommendation virtual article 1, a recommendation virtual article 2, and a recommendation virtual article 3 is used. If a part corresponding to the recommendation virtual article 1 is a bed, a part corresponding to the recommendation virtual article 2 is a curtain, a part corresponding to the recommendation virtual article 3 is a window, and the part to which the recommendation virtual article 3 belongs and the part to which the target virtual article belongs are both “windows”, a selection priority of the recommendation virtual article 3 is the highest. The part (the curtain) to which the recommendation virtual article 2 belongs and the part (the window) to which the target virtual article belongs have a direct association and attachment relationship (the curtain may be mounted on the window), and the part (the bed) to which the recommendation virtual article 1 belongs and the part (the window) to which the target virtual article belongs do not have the direct association and attachment relationship, so that a selection priority of the recommendation virtual article 2 is higher than a selection priority of the recommendation virtual article 1. In this case, when the recommendation virtual article corresponding to the “pastoral style” is displayed, the recommendation virtual article 3 whose belonging part is consistent with the part (that is, the window) to which the target virtual article belongs is displayed. That is, the recommendation virtual article 3 (the window), the recommendation virtual article 2 (the curtain), and the recommendation virtual article 1 (the bed) are sequentially displayed. In this way, the player can quickly select a recommendation virtual article whose belonging style and part are closest to the part and the style to which the target virtual article belongs, thereby facilitating improvement of the efficiency of screening the virtual article and the efficiency of constructing the virtual building.

In an actual application, when the player selects the part label corresponding to the target virtual article, the terminal displays, in response to the selection operation, the recommendation virtual article corresponding to the part to which the target virtual article belongs. If a plurality of recommendation virtual articles are provided, the terminal may determine selection priorities of the recommendation virtual articles, and display the recommendation virtual articles in a display manner corresponding to the selection priorities. For example, an association degree between a construction style corresponding to each of the recommendation virtual articles and the construction style of the target virtual article may be further obtained (where the larger the association degree, the higher the corresponding selection priority), and the recommendation virtual articles are sequentially displayed in descending order of association degrees.

For example, if the part to which the target virtual article belongs is the “window” and the corresponding construction style is the “pastoral style”, when the player selects the part label of the target virtual article, the terminal determines, in response to the selection operation, a plurality of selectable recommendation virtual articles, for example, a window 1, a window 2, and a window 3. When a display order is determined, the terminal may further obtain a construction style corresponding to each of the recommendation virtual articles, for example, a construction style corresponding to the window 1 is the “fresh style”, a construction style corresponding to the window 2 is the “pastoral style”, and a construction style corresponding to the window 3 is the “simple style”; and determine an association degree between the construction style corresponding to each of the recommendation virtual articles and the construction style of the target virtual article, and sequentially display the recommendation virtual articles in descending order of association degrees. For example, an association degree between the construction style corresponding to the window 2 and the construction style of the target virtual article is greater than an association degree between the construction style corresponding to the window 1 and the construction style of the target virtual article, and the association degree between the construction style corresponding to the window 1 and the construction style of the target virtual article is greater than an association degree between the construction style corresponding to the window 3 and the construction style of the target virtual article, that is, selection priorities of the window 2, the window 1, and the window 3 sequentially decrease, so that the window 2, the window 1, and the window 3 are sequentially displayed. In this way, the player can quickly select a recommendation virtual article whose belonging part and style are closest to the part and the style to which the target virtual article belongs, thereby facilitating improvement of the efficiency of screening the virtual article and the efficiency of constructing the virtual building.

Operation 103: Place a target recommendation article in the virtual building in response to a selection operation on the target recommendation article. For example, based on a selection operation performed on a target virtual object of the at least one recommended virtual object, the target virtual object is added to the virtual building.

In an actual application, when the player selects the target recommendation article in the at least one recommendation virtual article, the terminal may directly place, in response to the selection operation, the target recommendation article in the virtual building. For example, when the player selects the part label corresponding to the target virtual article, the recommendation virtual article is a virtual article corresponding to a part the same as the part to which the target virtual article belongs. In this case, the target virtual article in the virtual building may be directly replaced with the selected target recommendation article.

For another example, when the player selects the style label corresponding to the target virtual article, the recommendation virtual article is a virtual article corresponding to a target style the same as or similar to the construction style corresponding to the target virtual article, and a part to which the recommendation virtual article belongs may be the same as or different from the part to which the target virtual article belongs. When the target recommendation article selected by the player is the virtual article corresponding to the part the same as the part to which the target virtual article belongs, the target virtual article in the virtual building may be directly replaced with the selected target recommendation article. When the target recommendation article selected by the player is the virtual article corresponding to the part different from the part to which the target virtual article belongs, the target recommendation article may be directly placed at a target location in the virtual building. The target location is a location of the part to which the target recommendation article belongs in the virtual building.

If a virtual article (that is, an original virtual article) has existed at the target location before the target recommendation article is placed at the target location, that the target recommendation article may be placed at the target location in the virtual building is that the original virtual article at the target location is replaced with the target recommendation article. If no virtual article exists at the target location before the target recommendation article is placed at the target location, that the target recommendation article may be placed at the target location in the virtual building is that the target recommendation article is newly placed at the target location in the virtual building.

In some aspects, the terminal may further place the target recommendation article in the virtual building in response to the selection operation on the target recommendation article in the following manner: displaying, in response to the selection operation on the target recommendation article, a replacement control and an arrangement control corresponding to the target recommendation article; placing, when a trigger operation on the replacement control is received, the target recommendation article in the virtual building, to replace an original virtual article in the virtual building; and placing, when a trigger operation on the arrangement control is received, the target recommendation article at a target location in the virtual building, to newly create the target recommendation article at the target location.

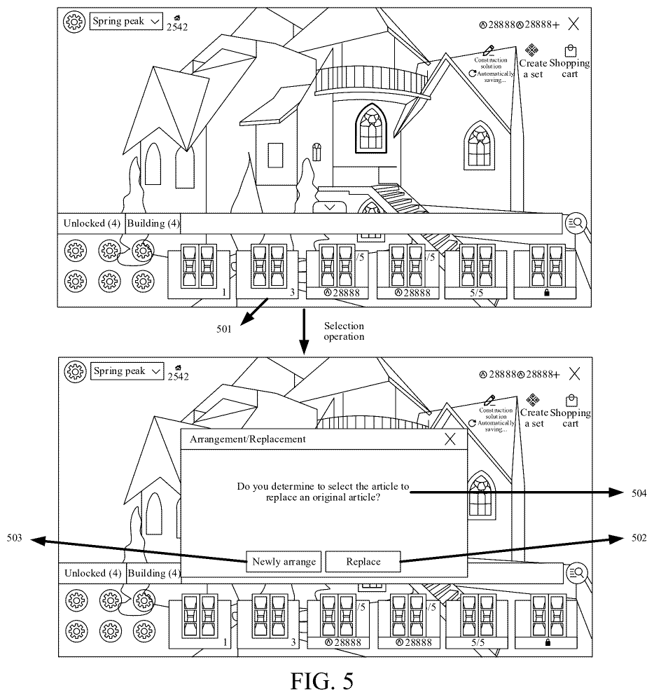

FIG. 5 is a schematic diagram of arranging a virtual article according to an aspect of this disclosure. When the player selects a target recommendation article 501 in at least one recommendation virtual article, the terminal may display, in response to the selection operation, a replacement control 502 and an arrangement control 503 corresponding to the target recommendation article. The replacement control 502 is configured to replace an original virtual article in the virtual building with the target recommendation article 501. The arrangement control 503 is configured to newly arrange the target recommendation article 501 in the virtual building. In addition, placement prompt information 504 (for example, do you determine to select the article to replace the original article? or, do you determine to select the article to be newly arranged?) may be further displayed. Based on the placement prompt information 504, when the player triggers the replacement control, the terminal places, in response to the trigger operation, the target recommendation article in the virtual building, to replace the original virtual article in the virtual building. When the player triggers the arrangement control, the terminal places, in response to the trigger operation, the target recommendation article at a target location in the virtual building, to newly create (that is, newly arrange) the target recommendation article at the target location. The target location is in a placeable state, that is, no other virtual article is arranged at the target location.

In some aspects, the terminal may place, in the following manner, the target recommendation article in the virtual building, to replace the original virtual article in the virtual building: placing, when a part to which the target recommendation article belongs is consistent with the part to which the target virtual article belongs, the target recommendation article at a location of the target virtual article in the virtual building, to replace the target virtual article; and placing, when the part to which the target recommendation article belongs is inconsistent with the part to which the target virtual article belongs, the target recommendation article at a location of another virtual article in the virtual building, to replace the another virtual article, where the part to which the target recommendation article belongs is consistent with the part to which the another virtual article belongs.

In an actual application, when the part to which the target virtual article triggered by the user belongs is consistent with the part to which the selected target recommendation article belongs, the target recommendation article may be directly placed at the location of the target virtual article in the virtual building, to replace the target virtual article. For example, when the player triggers the target virtual article (for example, a window 0) in the virtual building, the terminal displays, in response to the trigger operation, at least one selectable recommendation virtual article such as a window 1, a window 2, and a window 3. When the player selects the target recommendation article (for example, the window 3), the terminal determines, in response to the trigger operation, whether the part to which the target recommendation article (that is, the window 3) belongs is consistent with the part to which the target virtual article belongs. When it is determined that the part to which the target recommendation article (that is, the window 3) belongs is consistent with the part to which the target virtual article belongs (that is, the part to which the target recommendation article belongs and the part to which the target virtual article belongs are both windows), the terminal directly replaces the target virtual article (that is, the window 0) in the virtual building with the target recommendation article (that is, the window 3). In this way, during construction of the virtual building, a virtual article is quickly replaced, to improve efficiency of replacing the virtual article, thereby facilitating improvement of the efficiency of constructing the virtual building.

In some aspects, the terminal may place, in the following manner, the target recommendation article at the location of the target virtual article in the virtual building, to replace the target virtual article: placing, when another virtual article whose belonging part is consistent to the part to which the target virtual article belongs exists in the virtual building, the target recommendation article at locations of the target virtual article and the another virtual article in the virtual building, to replace the target virtual article and the another virtual article.

In an actual application, when the another virtual article whose belonging part is consistent to the part to which the target virtual article belongs also exists in the virtual building, the target recommendation article may be one-tap placed at locations of a plurality of virtual articles belonging to the same part (for example, the target virtual article and the another virtual article belonging to the same part) in the virtual building, to implement one-tap replacement of the plurality of virtual articles belonging to the same part. For example, when the player triggers the target virtual article (whose belonging part is the window) in the virtual building, the terminal displays, in response to the trigger operation, at least one selectable recommendation virtual article, for example, a window 1, a window 2, and a window 3. When the player selects the target recommendation article (for example, the window 3), the terminal determines, in response to the trigger operation, whether the part to which the target recommendation article (that is, the window 3) belongs is consistent with the part to which the target virtual article belongs. When it is determined that the part to which the target recommendation article (that is, the window 3) belongs is consistent with the part to which the target virtual article belongs (that is, the part to which the target recommendation article belongs and the part to which the target virtual article belongs are both windows), it is further determined whether another virtual article whose belonging part is the same as the part to which the target virtual article belongs exists in the virtual building (that is, whether another window is in the virtual building). When it is determined that another virtual article whose belonging part is the same as the part to which the target virtual article belongs exists in the virtual building (that is, there is another window), for example, a virtual article 1 and a virtual article 2, the target virtual article, the virtual article 1, and the virtual article 2 in the virtual building are one-tap replaced with the target recommendation article (that is, the window 3). In this way, a plurality of virtual articles are quickly replaced once, to improve efficiency of replacing the virtual articles, thereby facilitating improvement of the efficiency of constructing the virtual building.

In an actual application, when the part to which the target virtual article triggered by the user belongs is inconsistent with the part to which the selected target recommendation article belongs, the target recommendation article may be placed at the location of the another virtual article whose belonging part is consistent with the part to which the target recommendation article belongs in the virtual building, to replace the another virtual article whose belonging part is consistent with the part to which the target recommendation article belongs. When parts to which a plurality of other virtual articles belong are consistent with the part to which the target recommendation article belongs, the plurality of other virtual articles whose belonging parts are consistent with the part to which the target recommendation article belongs in the virtual building may be one-tap replaced with the target recommendation article.

For example, when the player triggers the target virtual article (for example, the window) in the virtual building, the terminal displays, in response to the trigger operation, at least one selectable recommendation virtual article, for example, a table light 1, a chair 1, and a chair 2. In this case, the recommendation virtual article may be a virtual article of an association style associated with the construction style of the target virtual article. When the user selects the target recommendation article (for example, the table light 1), the terminal determines, in response to the trigger operation, whether the part to which the target recommendation article (that is, the table light 1) belongs is consistent with the part to which the target virtual article (for example, the window) belongs. When it is determined that the part to which the target recommendation article (that is, the table light 1) belongs is inconsistent with the part to which the target virtual article (for example, the window) belongs (that is, the part to which the selected target recommendation article belongs is the table light, and the part to which the target virtual article belongs is the window), the terminal determines whether a table light has been arranged in the virtual building. When it is determined that the table light has been arranged in the virtual building, the arranged table light is replaced with the target recommendation article (that is, the table light 1). When a plurality of table lights have been arranged in the virtual building, the plurality of arranged table lights may be one-tap replaced with the target recommendation article (that is, the table light 1). In this case, during construction of the virtual building, the target virtual article is triggered, to implement replacement of another virtual article different from the target virtual article, break limitations on space and an article, and implement cross-article replacement, thereby sufficiently expanding a replacement scope of a virtual article in the virtual building. In addition, the virtual article is also quickly replaced, to improve efficiency of replacing the virtual article, thereby facilitating improvement of the efficiency of constructing the virtual building.

In some aspects, the terminal may place the target recommendation article at the target location in the virtual building in the following manner: controlling, in response to a drag operation on the target recommendation article, the target recommendation article to move in the virtual building, and displaying a location of the target recommendation article in a first pattern during the movement of the target recommendation article; and placing, when the target recommendation article moves to the target location and a display pattern of the target location is a second pattern, the target recommendation article at the target location in response to a release instruction for the drag operation, where the first pattern is different from the second pattern, the first pattern is configured for indicating that the location of the target recommendation article is in an unplaceable state, and the second pattern is configured for indicating that the target location is in a placeable state.

In an actual application, after the target recommendation article and the arrangement control are selected, the player may drag the target virtual article to move on a construction interface or in the virtual building, and during the movement of the target recommendation article, the location of the target recommendation article is displayed in a target pattern in real time (that is, the location is moved in real time), to indicate a placement status of the location of the target recommendation article (that is, whether the target recommendation article can be placed at the current location, including the placeable state and the unplaceable state). Alternatively, when the target recommendation article moves to a location of a target part in the virtual building, the location of the target part is displayed in the target pattern (for example, a block of the target part is displayed in the target pattern), to indicate a placement status of the location of the target part (that is, whether the target recommendation article can be placed at the location of the target part). If the target recommendation article cannot be placed at the location of the target part (that is, the location of the target part is in the unplaceable state), the block of the target part may be displayed in the first pattern, for example, in a red block. If the target recommendation article can be placed at the location of the target part (that is, the location of the target part is in the placeable state), the block of the target part may be displayed in the second pattern, for example, in a green block. When the target recommendation article moves to the target location in the placeable state, the release instruction for the target recommendation article can be triggered (for example, the player releases the drag operation on the target recommendation article); and the terminal places, in response to the release instruction, the target recommendation article at the target location.

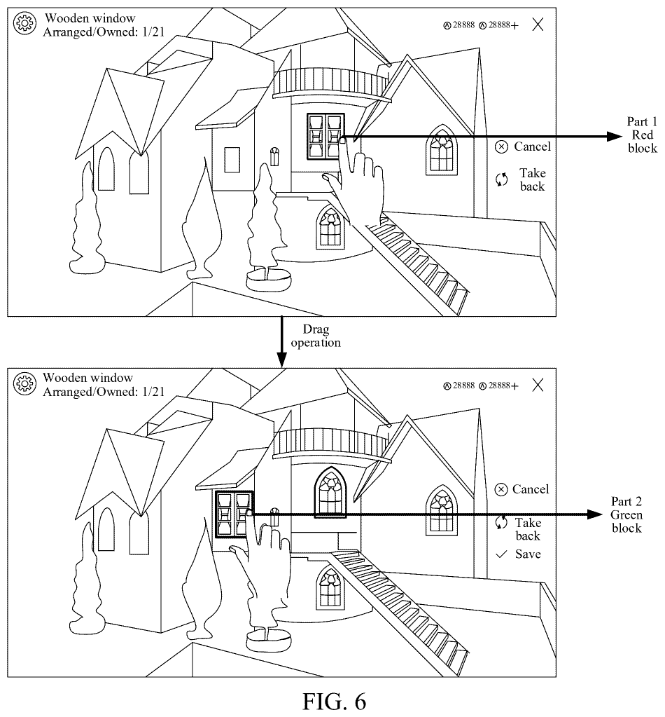

FIG. 6 is a schematic diagram of placing a virtual article according to an aspect of this disclosure. In an application scenario in which the player selects an arrangement control (that is, a virtual article is newly arranged in the virtual building, instead of replacing an original virtual article), when a target recommendation article moves to a location of a part 1 (for example, a window 1), if the location of the part 1 is in an unplaceable state (for example, another virtual article has been placed at the location of the part 1), a block of the part 1 may be displayed in a first pattern (for example, a red block), to indicate that the target recommendation article cannot be placed at the location of the part 1. When the target recommendation article moves to a location of a part 2 (for example, a window 2), if the location of the part 2 is in a placeable state (for example, no other virtual article is placed at the location of the part 2), a block of the part 2 may be displayed in a second pattern (for example, a green block), to indicate that the target recommendation article may be placed at the location of the part 2. In this case, if the player releases a drag operation on the target recommendation article or taps a save button, the terminal receives a release instruction to place the target recommendation article at the location of the part 2.

In the foregoing manner, a location at which the target recommendation article can be placed is indicated by changing a display pattern of a current moving location of the target recommendation article through the drag operation on the target recommendation article, to guide arrangement of the target recommendation article, so that accuracy and pertinence of a location at which a virtual article is arranged can be improved, thereby facilitating improvement of the efficiency of constructing the virtual building.

In some aspects, the terminal may place the target recommendation article at the target location in the virtual building in the following manner: displaying guide indication information corresponding to the target location in the virtual building, where the guide indication information is configured for guiding to drag the target recommendation article to the target location in a placeable state; controlling the target recommendation article to move toward the target location in response to the drag operation on the target recommendation article triggered based on the guide indication information; and placing, when the target recommendation article moves to the target location, the target recommendation article at the target location in response to a release instruction for the drag operation.

In an actual application, during the movement of the target recommendation article, the corresponding guide indication information may be displayed at the target location in the placeable state, to guide to drag the target recommendation article to the target location. The guide indication information may be presented in a form of text description. For example, the guide indication information may be described as: “This is where you can place the selected virtual article”. Alternatively, the target location may be displayed in a target display pattern (for example, displayed in highlight, or displayed in a target color) to highlight the target location in the placeable state, so that the target location is distinguished from another location in the unplaceable state, and the target location displayed in the target display pattern is used as the guide indication information. In this case, the player may release the drag operation on the target recommendation article after dragging the target recommendation article to the target location under the guidance of the guide indication information, and the terminal may place the target recommendation article at the target location after the release instruction is received.

When a plurality of target locations in the placeable state are provided, guide indication information corresponding to the plurality of target locations may be displayed, the guide indication information corresponding to the target locations may be displayed in different display patterns based on different placement priorities of the target locations, and guide indication information corresponding to a target location with a highest placement priority is displayed in highlight, to drag and place the target recommendation article at the target location with the highest placement priority in a targeted manner.

In the foregoing manner, the player may quickly drag, by using the guide indication information displayed in the virtual building, the target recommendation article to the target location indicated by the guide indication information, to place the target recommendation article at the target location. In this way, accuracy and pertinence of a location at which a virtual article is arranged are improved while efficiency of placing the virtual article is improved, thereby facilitating improvement of the efficiency of constructing the virtual building.

In some aspects, after the target recommendation article is placed in the virtual building, the terminal may further display a configuration detail page of the virtual building in response to a configuration viewing operation on the virtual building; and display a selection identifier and a recall control for the target recommendation article on the configuration detail page, the recall control being configured to recall the target recommendation article placed in the virtual building.

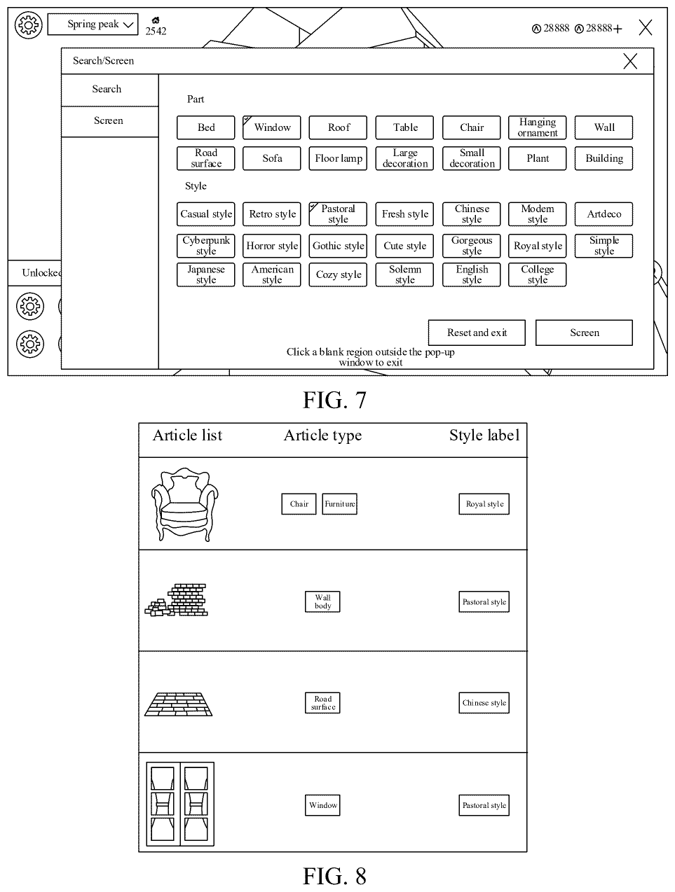

FIG. 7 is a schematic diagram of details of virtual articles according to an aspect of this disclosure. After a target recommendation article is placed in a virtual building, the player may trigger a configuration viewing operation on the virtual building by triggering a configuration viewing control (for example, a search control or a screening control). The terminal displays, in response to the configuration viewing operation, a configuration detail page of the virtual building, and displays, on the configuration detail page, all part categories and style categories configured by a system, and a selection identifier corresponding to the target recommendation article that has been placed in the virtual building. For example, when a part corresponding to the target recommendation article is a window and a style corresponding to the target recommendation article is a pastoral style, the selection identifier is displayed on both the part category of the window and the style category of the pastoral style. In addition, a recall control may be further displayed on the configuration detail page. The recall control may be configured to recall or delete a placed virtual article in the virtual building. For example, the placed target recommendation article is recalled or deleted, so that the virtual building is restored to a state before the target recommendation article is placed. In this way, the player may recall or delete a placed virtual article based on an actual requirement and may newly place another virtual article, thereby improving flexibility of virtual article placement.

In the foregoing manner, during construction a virtual building, when a player intends to replace or newly place a virtual article in the virtual building, if a target virtual article in the virtual building is triggered, one or more selectable recommendation virtual articles are displayed on a construction interface. The player may select a target recommendation article therefrom and place the target recommendation article in the virtual building, to replace the target virtual article in the virtual building, or newly create the target recommendation article in the virtual building. In this way, the player can select the needed target recommendation article in the recommendation virtual article without screening level by level. Compared with the related art, an operation path for replacing or newly placing a virtual article is greatly shortened, operations are simplified, and operation efficiency is improved. In addition, the recommendation virtual article corresponds to a recommendation label of the target virtual article, that is, the recommendation virtual article is recommended based on the recommendation label of the target virtual article. Therefore, pertinence and accuracy of virtual article recommendation can be improved, and the player can select a satisfying target recommendation article to construct the virtual building, thereby improving efficiency of constructing the virtual building.

The following describes an example application of the aspects of this disclosure in an actual application scenario. Using an example in which a virtual scenario is a constructive game, before a player constructs a virtual building in the constructive game, a developer of the constructive game may configure a part label (or an article type) and a style label of a virtual article related to the virtual building. FIG. 8 is a schematic diagram of settings of virtual articles according to an aspect of this disclosure. A plurality of configured virtual articles are presented in an article list, and each of the virtual articles is configured with a corresponding article type (that is, the part label) and a corresponding style label. In addition, the developer may further configure association data (for example, an association degree) between style labels. Usually, the similar two different style labels, the larger an association degree between the two style labels. For example, an association degree between a fresh style and a pastoral style is 90, and an association degree between a retro style and the pastoral style is 20. The developer may store configuration data in a background server, and may update in real time, based on actual requirements, the configuration data of all the virtual articles stored in the background server, such as the part labels, the style labels, and association degrees between different style labels.

Next, the virtual article processing method provided in the aspects of this disclosure continues to be described. FIG. 9 is a schematic flowchart of a virtual article processing method according to an aspect of this disclosure. The method includes the following operations:

Operation 201: A terminal displays a virtual building on a construction interface of a virtual scenario, the virtual building including at least one virtual article. For example, a construction interface of a virtual building is output for display in a virtual scene. The virtual building includes at least one virtual object.

Using an example in which the virtual building is a house, the virtual article may be a component or assembly like a window, a door, a wall, a roof, a floor, or furniture (such as a desk, a chair, a table light, a bed, or a sofa) in the house. The virtual articles are configured for constructing the virtual building like the house, and are components of the virtual building.

Operation 202: Display, in response to a trigger operation on a target virtual article in the virtual building, at least two selectable recommendation labels. For example, at least one selectable recommendation label is output for display.

In an actual application, a player actually performs a trigger operation on a target region in the virtual building. The terminal recognizes, in response to the trigger operation, a virtual article in the target region, uses the recognized virtual article as the target virtual article, and uses the trigger operation on the target region as the trigger operation on the target virtual article.

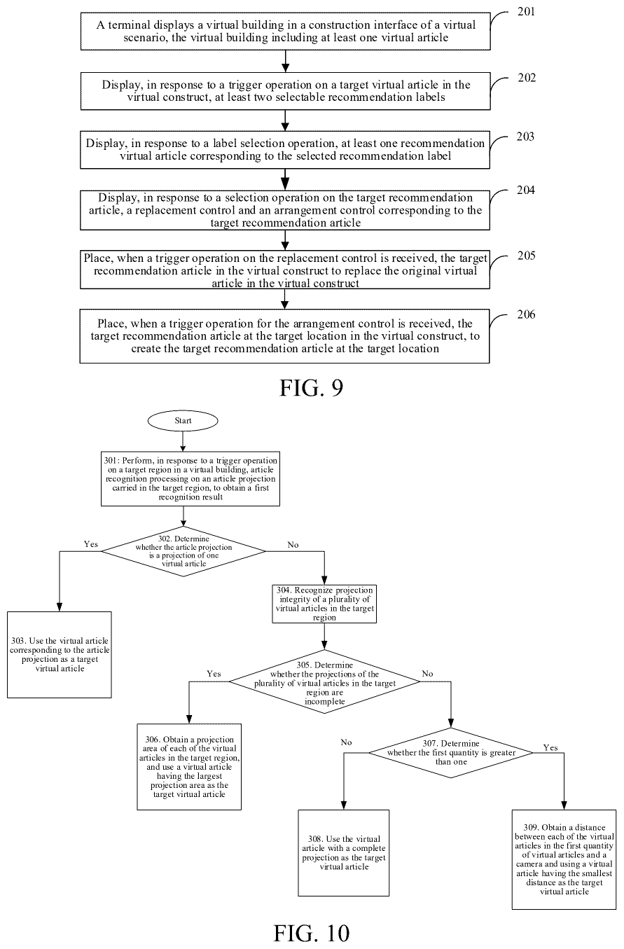

FIG. 10 is a schematic flowchart of a virtual article recognition method according to an aspect of this disclosure. The method includes the following operations:

Operation 301: Perform, in response to a trigger operation on a target region in a virtual building, article recognition processing on an article projection carried in the target region, to obtain a first recognition result.

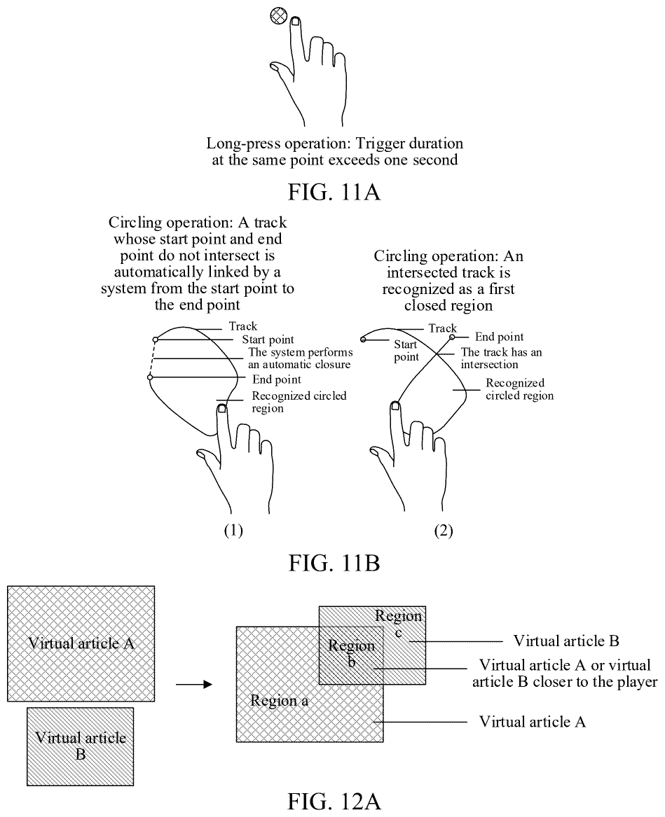

The trigger operation may be an operation in a form like a single-tap operation, a long-press operation, or a circling operation, or certainly may be another trigger manner. The trigger operation manner is not limited in the aspects of this disclosure. FIG. 11A and FIG. 11B are schematic diagrams of displaying a trigger manner according to an aspect of this disclosure. An example in which the player triggers the foregoing trigger operation by using a finger to trigger a target region is used. In FIG. 11A, the terminal determines duration for which the finger of the player triggers the target region, and considers a trigger operation whose trigger duration exceeds target duration (for example, one second) as a long-press operation. In FIG. 11B, the terminal recognizes a circling operation and a circled region corresponding to the circling operation by using a continuous track drawn by the finger of the player. As shown in (1) of FIG. 11B, when the track is not closed, a system automatically links a start point and an end point of a gesture of the player, and uses a closed region obtained through linking as the circled region corresponding to the circling operation. As shown in (2) of FIG. 11B, when a closed region exists in the track, the system uses a closed region generated by a first intersection in the track as the circled region corresponding to the circling operation.

The target region is a contact region (for example, when the trigger operation is the long-press operation, the target region is a region long-pressed by the finger) or a circled region (for example, when the trigger operation is the circling operation, the target region is a circled region by the finger) by the finger on the virtual building when the player triggers the foregoing trigger operation on the virtual building.

Operation 302: Determine whether the article projection is a projection of one virtual article.

Whether the article projection is the projection of one virtual article is determined based on the first recognition result. When the first recognition result represents that the article projection carried in the target region is the projection of one virtual article, operation 303 is performed. Otherwise, operation 304 is performed.

Operation 303: Use the virtual article corresponding to the article projection as a target virtual article.

Operation 304: Recognize integrity of projections of a plurality of virtual articles in the target region.

When the first recognition result represents that the article projection carried in the target region is the projections of the plurality of virtual articles, integrity of the projections of the plurality of virtual articles in the target region is recognized, to obtain a second recognition result.

Operation 305: Determine whether the projections of the plurality of virtual articles in the target region each are incomplete.

Whether the projections of the plurality of virtual articles in the target region each are incomplete is determined based on the second recognition result. When the second recognition result represents that the projections of the plurality of virtual articles in the target region each are incomplete, operation 306 is performed. When the second recognition result represents that projections of a first quantity of virtual articles in the plurality of virtual articles are complete and projections of a second quantity of virtual articles are incomplete, operation 307 is performed.

Operation 306: Obtain a projection area of each of the virtual articles in the target region, and use a virtual article having a largest projection area as the target virtual article.

Operation 307: Determine whether the first quantity is greater than 1.

The first quantity is a positive integer. When the first quantity is equal to 1, operation 308 is performed. When the first quantity is greater than 1, operation 309 is performed.

Operation 308: Use the virtual article with the complete projection as the target virtual article.

Operation 309: Obtain a distance between each of the virtual articles in the first quantity of virtual articles and a camera, and use a virtual article having a shortest distance as the target virtual article.

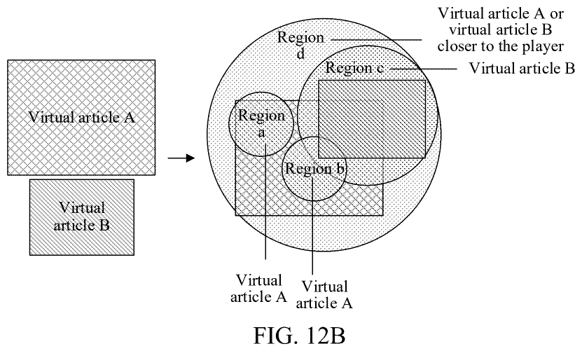

FIG. 12A and FIG. 12B are schematic diagrams of recognizing a virtual article according to an aspect of this disclosure. In FIG. 12A, an example in which a trigger operation is a long-press operation is used. An independent region of a virtual article A is a region a, an independent region of a virtual article B is a region c, and an overlapping region of the virtual article A and the virtual article B is a region b. When the finger of the player long-presses the region a, the system recognizes that a target virtual article is the virtual article A. When the finger of the player long-presses the region c, the system recognizes that the target virtual article is the virtual article B. When the finger of the player long-presses the region b, the system recognizes a front-back relationship between the virtual article A and the virtual article B relative to the player (that is, the camera) and uses a virtual article closer to the player as the target virtual article; or the system recognizes trigger areas corresponding to the virtual article A and the virtual article B that are triggered by the player in the region b, and uses a virtual article having a larger trigger area as the target virtual article.

In FIG. 12B, an example in which a trigger operation is a circling operation is used. The system determines a target virtual article based on projections (in which an occluded part is not considered) of virtual articles included in a circled region (that is, a target region) under a viewing angle. A region a includes only a projection of a virtual article A, a region b includes a partial projection of the virtual article A and a partial projection of a virtual article B, a region c includes a complete projection of the virtual article B and a partial projection of the virtual article A, and a region d includes a complete projection of the virtual article A and the complete projection of the virtual article B. When the finger of the player circles the region a, because the region a includes only the projection of the virtual article A, the system recognizes that the target virtual article is the virtual article A. When the finger of the player circles the region b, because the region B includes the partial projection of the virtual article A and the partial projection of the virtual article B, the system recognizes projections (in which the occluded part is not considered) of exposed parts of the virtual article A and the virtual article B in the region b under the viewing angle, and finally uses a virtual article having a larger projection area as the target virtual article. When the finger of the player circles the region c, because the region c includes the complete projection of the virtual article B and the partial projection of the virtual article A, the system recognizes that the target virtual article is the virtual article B with the complete projection. When the finger of the player circles the region d, because the region d includes the complete projection of the virtual article A and the complete projection of the virtual article B, the system finally recognizes, in the virtual article A and the virtual article B, a virtual article closer to the player as the target virtual article.

Through the foregoing operations, the virtual article in the target region is recognized, the recognized virtual article is used as a target virtual article, and the trigger operation on the target region is used as the trigger operation on the target virtual article.

Operation 203: Display, in response to a label selection operation, at least one recommendation virtual article corresponding to a selected recommendation label. For example, a label selection operation performed on one of the at least one selectable recommendation label is received. The at least one recommended virtual object is output for display based on the label selection operation. The at least one recommended virtual object is determined based on the recommendation label on which the label selection operation is performed.

The recommendation label is configured for indicating a recommendation dimension for the target virtual article. For example, the recommendation label may be a label for recommending a similar part, recommending a similar style, or the like. The label for recommending the similar part is configured for indicating to recommend a virtual article corresponding to a part to which the target virtual article belongs, and the label for recommending the similar style is configured for indicating to recommend a virtual article corresponding to a construction style of the target virtual article.

After the player selects the recommendation label, the terminal displays, in response to the selection operation, the recommendation virtual article corresponding to the selected recommendation label, for selection and use by the player. For example, when the selected recommendation label indicates to recommend the virtual article corresponding to the part to which the target virtual article belongs, at least one recommendation virtual article corresponding to the part is displayed. For example, when the part to which the target virtual article belongs is a window, a plurality of selectable windows are displayed as recommendation virtual articles. For another example, when the part to which the target virtual article belongs is a roof, a plurality of selectable roofs are displayed as recommendation virtual articles. When the selected recommendation label indicates to recommend the virtual article corresponding to the construction style of the target virtual article, a recommendation virtual article corresponding to a target style is displayed. The target style includes at least one of the construction style corresponding to the target virtual article or an association style associated with the construction style corresponding to the target virtual article. For example, the construction style of the target virtual article is a pastoral style, and an association style associated with the pastoral style may be a fresh style, a simple style, or the like. In this case, the target style may include the pastoral style, the fresh style, and the simple style. In other words, recommendation virtual articles corresponding to corresponding styles may be sequentially displayed in descending order of association degrees.

Operation 204: Display, in response to a selection operation on the target recommendation article, a replacement control and an arrangement control corresponding to the target recommendation article. For example, a replacement control element and a placement control element corresponding to the target virtual object are output for display based on the selection operation performed on the target virtual object.

The replacement control is configured to replace an original virtual article in the virtual building with the target recommendation article. The arrangement control is configured to newly arrange the target recommendation article in the virtual building. In addition, placement prompt information (for example, do you determine to select the article to replace the original article? or, do you determine to select the article to be newly arranged?) may be further displayed, to prompt the player to select a placement manner for the target recommendation article, for example, replacing the original virtual article in the virtual building or newly creating the target recommendation article in the virtual building.

Operation 205: Place, when a trigger operation on the replacement control is received, the target recommendation article in the virtual building, to replace the original virtual article in the virtual building. For example, based on a trigger operation performed on the replacement control element, the target virtual object is placed in the virtual building to replace an original virtual object in the virtual building

When the part to which the target virtual article triggered by a user belongs is consistent with a part to which the selected target recommendation article belongs, the target recommendation article may be directly placed at a location of the target virtual article in the virtual building, to replace the target virtual article. In this way, a virtual article is quickly replaced, to improve efficiency of replacing the virtual article, thereby facilitating improvement of efficiency of constructing the virtual building.

When the part to which the target recommendation article belongs is inconsistent with the part to which the target virtual article belongs, the target recommendation article may be placed at a location of another virtual article in the virtual building, to replace the another virtual article. The part to which the target recommendation article belongs is consistent with the part to which the another virtual article belongs. In other words, the target recommendation article is placed at the location of the another virtual article whose belonging part is consistent with the part to which the target recommendation article belongs in the virtual building, to replace the another virtual article whose belonging part is consistent with the part to which the target recommendation article belongs. In this case, during construction of the virtual building, the target virtual article is triggered, to implement replacement of the another virtual article different from the target virtual article, break limitations on space and an article, and implement cross-article replacement, thereby sufficiently expanding a replacement scope of a virtual article in the virtual building. In addition, the virtual article is also quickly replaced, to improve efficiency of replacing the virtual article, thereby facilitating improvement of efficiency of constructing the virtual building.

Operation 206: Place, when a trigger operation on the arrangement control is received, the target recommendation article at a target location in the virtual building, to newly create the target recommendation article at the target location. For example, based on a trigger operation performed on the placement control element, the target virtual object is placed at a target location in the virtual building to add the target virtual object at the target location.

In an actual application, after the target recommendation article and the arrangement control are selected, the player may drag the target virtual article to move on the construction interface or in the virtual building. When the target recommendation article moves to a location of a target part in the virtual building, the location of the target part may be displayed in a target pattern (for example, a block of the target part is displayed in the target pattern), to indicate a placement status of the location of the target part (that is, whether the target recommendation article can be placed at the location of the target part). If the target recommendation article cannot be placed at the location of the target part (that is, the location of the target part is in an unplaceable state, for example, another virtual article has been placed), the block of the target part may be displayed in a first pattern, for example, in a red block. If the target recommendation article can be placed at the location of the target part (that is, the location of the target part is in a placeable state, for example, no another virtual article is not placed), the block of the target part may be displayed in a second pattern, for example, in a green block. When the target recommendation article moves to the target location in the placeable state, a release instruction for the target recommendation article can be triggered (for example, the player releases a drag operation on the target recommendation article); and the terminal places, in response to the release instruction, the target recommendation article at the target location, to newly create (that is, newly arrange) the target recommendation article at the target location.

In the foregoing manner, a location at which the target recommendation article can be placed is indicated by changing a display pattern of a current moving location of the target recommendation article through the drag operation on the target recommendation article, to guide arrangement of the target recommendation article, so that accuracy and pertinence of a location at which a virtual article is arranged can be improved.

The virtual article processing method provided in the aspects of this disclosure is described with reference to the example applications and implementations of the electronic device provided in the aspects of this disclosure. The following further describes how the modules in a virtual article processing apparatus 555 provided in the aspects of this disclosure cooperate with each other to implement a virtual article processing solution.

A first display module 5551 is configured to display a virtual building on a construction interface of a virtual scenario, the virtual building including at least one virtual article; a second display module 5552 is configured to display, in response to a trigger operation on a target virtual article, at least one recommendation virtual article, the recommendation virtual article corresponding to a recommendation label of the target virtual article; and an article placement module 5553 is configured to place a target recommendation article in the virtual building in response to a selection operation on the target recommendation article.

In some aspects, the second display module is further configured to display at least one selectable recommendation label; and display, in response to a label selection operation, at least one recommendation virtual article corresponding to a selected recommendation label.

In some aspects, the second display module is further configured to display, when the selected recommendation label indicates to recommend a virtual article corresponding to a part to which the target virtual article belongs, at least one recommendation virtual article corresponding to the part; or display at least one recommendation virtual article corresponding to a target style when the selected recommendation label indicates to recommend a virtual article corresponding to a construction style of the target virtual article, where the target style includes at least one of the construction style or an association style associated with the construction style.

In some aspects, the second display module is further configured to determine, when a plurality of types of the target style are provided, an association degree between each type of the target style and the construction style; and sequentially display the at least one recommendation virtual article corresponding to the target style in descending order of association degrees.

In some aspects, the second display module is further configured to display, when at least two recommendation virtual articles are provided, a first quantity of recommendation virtual articles in the at least two recommendation virtual articles in a first display pattern, and display a second quantity of recommendation virtual articles in a second display pattern, where the first display pattern is different from the second display pattern, the first display pattern is configured for indicating that the first quantity of recommendation virtual articles are in a selectable state, and the second display pattern is configured for indicating that the second quantity of recommendation virtual articles are in an unselectable state.

In some aspects, the second display module is further configured to obtain, when the at least two recommendation virtual articles are provided, an influence parameter configured for influencing a selection priority of each of the recommendation virtual articles, where the influence parameter includes at least one of the following: a part to which the recommendation virtual article belongs, and an association degree between a construction style corresponding to the recommendation virtual article and the construction style corresponding to the target virtual article; and determine, based on the influence parameter, the selection priority of each of the recommendation virtual articles, and display each of the recommendation virtual articles in a display manner corresponding to the selection priority.

In some aspects, the article placement module is further configured to display, in response to the selection operation on the target recommendation article, a replacement control and an arrangement control corresponding to the target recommendation article; place, when a trigger operation on the replacement control is received, the target recommendation article in the virtual building, to replace an original virtual article in the virtual building; and place, when a trigger operation on the arrangement control is received, the target recommendation article at a target location in the virtual building, to newly create the target recommendation article at the target location.

In some aspects, the article placement module is further configured to place, when a part to which the target recommendation article belongs is consistent with the part to which the target virtual article belongs, the target recommendation article at a location of the target virtual article in the virtual building, to replace the target virtual article; and place, when the part to which the target recommendation article belongs is inconsistent with the part to which the target virtual article belongs, the target recommendation article at a location of another virtual article in the virtual building, to replace the another virtual article, where the part to which the target recommendation article belongs is consistent with a part to which the another virtual article belongs.

In some aspects, the article placement module is further configured to place, when another virtual article whose belonging part is consistent to the part to which the target virtual article belongs exists in the virtual building, the target recommendation article at locations of the target virtual article and the another virtual article in the virtual building, to replace the target virtual article and the another virtual article.

In some aspects, the article placement module is further configured to control, in response to a drag operation on the target recommendation article, the target recommendation article to move in the virtual building, and display a location of the target recommendation article in a first pattern during the movement of the target recommendation article; and place, when the target recommendation article moves to the target location and a display pattern of the target location is a second pattern, the target recommendation article at the target location in response to a release instruction for the drag operation, where the first pattern is different from the second pattern, the first pattern is configured for indicating that the location of the target recommendation article is in an unplaceable state, and the second pattern is configured for indicating that the target location is in a placeable state.

In some aspects, the article placement module is further configured to display guide indication information corresponding to the target location in the virtual building, where the guide indication information is configured for guiding to drag the target recommendation article to the target location in a placeable state; control the target recommendation article to move toward the target location in response to the drag operation on the target recommendation article triggered based on the guide indication information; and place, when the target recommendation article moves to the target location, the target recommendation article at the target location in response to a release instruction for the drag operation.

In some aspects, after the target recommendation article is placed in the virtual building, the apparatus further includes: a detail viewing module, configured to display a configuration detail page of the virtual building in response to a configuration viewing operation on the virtual building; and display a selection identifier and a recall control for the target recommendation article on the configuration detail page, the recall control being configured to recall the target recommendation article placed in the virtual building.

In some aspects, before the at least one recommendation virtual article is displayed, the apparatus further includes: an article recognition module, configured to perform, in response to a trigger operation on a target region in the virtual building, article recognition processing on an article projection carried in the target region, to obtain a first recognition result; use, when the first recognition result represents that the article projection carried in the target region is a projection of one virtual article, the virtual article corresponding to the article projection as a target virtual article; or recognize, when the first recognition result represents that the article projection carried in the target region is projections of a plurality of virtual articles, integrity of the projections of the plurality of virtual articles in the target region, to obtain a second recognition result, and determine a target virtual article based on the second recognition result; and use the trigger operation on the target region as a trigger operation on the target virtual article.

In some aspects, the article recognition module is further configured to obtain a projection area of each of the virtual articles in the target region when the second recognition result represents that the projections of the plurality of virtual articles in the target region each are incomplete, and use a virtual article having a largest projection area as the target virtual article; or when the second recognition result represents that projections of a first quantity of virtual articles in the plurality of virtual articles are complete and projections of a second quantity of virtual articles are incomplete, determine the target virtual article based on the first quantity of virtual articles.

In some aspects, the article recognition module is further configured to use, when the first quantity is 1, the virtual article with the complete projection as the target virtual article; or obtain, when the first quantity is greater than 1, a distance between each of the virtual articles in the first quantity of virtual articles and a camera, and use a virtual article having a shortest distance as the target virtual article, where the camera is configured to obtain the construction interface.

In some aspects, before the at least one recommendation virtual article is displayed, the apparatus further includes: a construction configuration module, configured to display an article configuration interface of the virtual building, and display a part setting control, a style setting control, and a style association control on the article configuration interface; set, in response to a part setting operation triggered based on the part setting control, a part to which the at least one virtual article in the virtual building belongs; set, in response to a style setting operation triggered based on the style setting control, a construction style corresponding to the virtual building or the at least one virtual article in the virtual building; set, in response to a style association operation triggered based on the style association control, an association degree between different construction styles, to obtain an association style corresponding to the construction style; and determine a recommendation label of the virtual article based on at least one of the part, the construction style, and the association style.

An aspect of this disclosure provides a computer program product. The computer program product includes a computer program or computer-executable instructions. The computer program or the computer-executable instructions are stored in a computer-readable storage medium. A processor of an electronic device reads the computer-executable instructions from the computer-readable storage medium. The processor executes the computer-executable instructions, to cause the electronic device to perform the virtual article processing method in the aspects of this disclosure.

An aspect of this disclosure provides a computer-readable storage medium, such as a non-transitory computer-readable storage medium. The computer-readable storage medium has computer-executable instructions or a computer program stored therein. When the computer-executable instructions or the computer program is executed by a processor, the processor is caused to perform the virtual article processing method provided in the aspects of this disclosure, for example, the virtual article processing method shown in FIG. 3.

In some aspects, the computer-readable storage medium may be a memory such as ferroelectric RAM (FRAM), ROM, programmable ROM (PROM), erasable programmable ROM (EPROM), electrically erasable programmable ROM (EEPROM), flash memory, magnetic surface memory, optical disk, or compact disc (CD-ROM). It may alternatively be a device that includes one or any combination of the above memory types.

In some aspects, the computer-executable instructions may be written in any form of programming language (including a compiled or interpreted language, or a declarative or procedural language) in the form of a program, software, a software module, a script, or code, and may be deployed in any form, including being deployed as an independent program or being deployed as a module, a component, a subroutine, or another unit suitable for use in a computing environment.

In an example, the computer-executable instructions may but do not necessarily correspond to a file in a file system, and may be stored as a part of a file that saves other programs or data, for example, stored in one or more scripts in a Hypertext Markup Language (HTML) document, stored in a single file dedicated to a discussed program, or stored in a plurality of collaborative files (for example, files that store one or more modules, subprograms, or code parts).

In an example, the computer-executable instructions may be deployed to be executed on one electronic device, executed on a plurality of electronic devices located at one position, or executed on a plurality of electronic devices that are distributed in a plurality of positions and interconnected by a communication network.

The foregoing descriptions are merely some aspects of this disclosure and are not intended to limit the scope of this disclosure. Any modification, equivalent replacement, or improvement made without departing from the spirit and range of this disclosure shall fall within the scope of this disclosure.

What is claimed is:

1. A virtual object processing method, comprising:
outputting for display a construction interface of a virtual building in a virtual scene, the virtual building including at least one virtual object;
outputting for display at least one recommended virtual object based on a trigger operation performed on a reference virtual object of the at least one virtual object of the virtual building, the at least one recommended virtual object being determined based on a recommendation label of the reference virtual object; and
adding, based on a selection operation performed on a target virtual object of the at least one recommended virtual object, the target virtual object to the virtual building.

2. The method according to claim 1, wherein the outputting for display the at least one recommended virtual object comprises:
outputting for display at least one selectable recommendation label;
receiving a label selection operation performed on one of the at least one selectable recommendation label; and
outputting for display the at least one recommended virtual object based on the label selection operation, wherein the at least one recommended virtual object is determined based on the recommendation label on which the label selection operation is performed.

3. The method according to claim 2, wherein the outputting for display the at least one recommended virtual object comprises:
outputting for display the at least one recommended virtual object corresponding to a same part type as the reference virtual object when the recommendation label indicates part type matching; and
outputting for display the at least one recommended virtual object corresponding to a target style when the recommendation label indicates a construction style of the reference virtual object, the target style including at least one of the construction style or an association style associated with the construction style.

4. The method according to claim 3, wherein the outputting for display the at least one recommended virtual object corresponding to the target style comprises:
determining, when a plurality of target styles are provided, an association degree between each of the plurality of target styles and the construction style; and
outputting for display the recommended virtual objects corresponding to the target styles in descending order of the association degrees.

5. The method according to claim 1, wherein the outputting for display the at least one recommended virtual object comprises:
outputting for display, when at least two recommended virtual objects are provided, a first group of the recommended virtual objects in a selectable state, and a second group of the recommended virtual objects in a non-selectable state.

6. The method according to claim 1, wherein the outputting for display the at least one recommended virtual object comprises:
obtaining, when at least two recommended virtual objects are provided, at least one influence parameter affecting a selection priority of the recommended virtual objects,
the influence parameter including at least one of:
a part type to which the recommended virtual object belongs, or
an association degree between a construction style of the recommended virtual object and the construction style of the reference virtual object;
determining the selection priority of each of the recommended virtual objects based on the influence parameter; and
outputting for display each of the recommended virtual objects according to the corresponding selection priority of the respective recommend virtual object.

7. The method according to claim 1, wherein the adding the target virtual object comprises:
outputting for display a replacement control element and a placement control element corresponding to the target virtual object based on the selection operation performed on the target virtual object;
placing, based on a trigger operation performed on the replacement control element, the target virtual object in the virtual building to replace an original virtual object in the virtual building; and
placing, based on a trigger operation performed on the placement control element, the target virtual object at a target location in the virtual building to add the target virtual object at the target location.

8. The method according to claim 7, wherein the placing the target virtual object in the virtual building to replace the original virtual object in the virtual building comprises:
placing, when the target virtual object belongs to a same part type as the reference virtual object, the target virtual object at a location of the reference virtual object to replace the reference virtual object; and
placing, when the target virtual object belongs to a different part type than the reference virtual object, the target virtual object at a location of another virtual object in the virtual building belonging to the same part type as the target virtual object to replace the another virtual object.

9. The method according to claim 8, wherein the placing the target virtual object in the virtual building to replace the original virtual object in the virtual building comprises:
placing a plurality of the target virtual object at locations of the reference virtual object and an additional virtual object when the additional virtual object belongs to the same part type as the target virtual object.

10. The method according to claim 7, wherein the placing the target virtual object at the target location comprises:
controlling, based on a drag operation performed on the target virtual object, the target virtual object to move within the virtual building;
outputting for display the location of the target virtual object in a non-placeable state; and
placing, based on a release of the drag operation when the target virtual object reaches the target location and the target location is displayed in a placeable state, the target virtual object at the target location.

11. The method according to claim 7, wherein the placing the target virtual object at the target location comprises:
outputting for display guidance information at the target location in the virtual building, the guidance information indicating that the target virtual object is placeable at the target location;
controlling the target virtual object to move toward the target location based on a drag operation that is performed based on the guidance information; and
placing, when the target virtual object moves to the target location, the target virtual object at the target location based on a release of the drag operation.

12. The method according to claim 1, further comprising:
outputting for display a configuration detail page of the virtual building based on a configuration viewing operation performed on the virtual building; and
outputting for display, on the configuration detail page, a selection identifier for the target virtual object and a undo control element configured to undo the adding of the target virtual object.

13. The method according to claim 1, further comprising:
performing, based on a trigger operation performed on a target region of the virtual building, object recognition processing on an object projection in the target region to obtain a first recognition result;
using, when the first recognition result indicates that the object projection corresponds to a single virtual object, the corresponding virtual object as the reference virtual object; and
determining, when the first recognition result indicates that the object projection corresponds to a plurality of virtual objects, the reference virtual object based on completeness of projections of the plurality of virtual objects in the target region.

14. The method according to claim 13, wherein the determining the reference virtual object comprises:
when the projections of each of the plurality of virtual objects in the target region are incomplete, determining the reference virtual object as the virtual object having a largest projection area; and
when the projections of a first subset of the plurality of virtual objects are complete, determining the reference virtual object from the first subset.

15. The method according to claim 14, wherein the determining the reference virtual object from the first subset comprises:
when the first subset includes a single virtual object, selecting the virtual object with the complete projection as the reference virtual object; and
when the first subset includes more than one virtual object, selecting, from the first subset, the virtual object having a shortest view distance.

16. The method according to claim 1, further comprising:
outputting for display an object configuration interface of the virtual building;
outputting for display, on the object configuration interface, a part type setting control element, a style setting control element, and a style association control element;
setting, based on a part setting operation performed on the part type setting control element, a part type to which each of the at least one virtual object belongs;
setting, based on a style setting operation performed on the style setting control element, a construction style of the virtual building of each of the at least one virtual object in the virtual building;
setting, based on a style association operation performed on the style association control element, an association degree between different construction styles to obtain an association style corresponding to the construction style; and
determining the recommendation label of each of the at least one virtual object based on at least one of the part type, the construction style, and the association style.

17. A virtual object processing apparatus, comprising:
processing circuitry configured to:
output for display a construction interface of a virtual building in a virtual scene, the virtual building including at least one virtual object;
output for display at least one recommended virtual object based on a trigger operation performed on a reference virtual object of the at least one virtual object of the virtual building, the at least one recommended virtual object being determined based on a recommendation label of the reference virtual object; and
add, based on a selection operation performed on a target virtual object of the at least one recommended virtual object, the target virtual object to the virtual building.

18. The apparatus according to claim 17, wherein the processing circuitry is configured to:
output for display at least one selectable recommendation label;
receive a label selection operation performed on one of the at least one selectable recommendation label; and
output for display the at least one recommended virtual object based on the label selection operation, wherein the at least one recommended virtual object is determined based on the recommendation label on which the label selection operation is performed.

19. The apparatus according to claim 18, wherein the processing circuitry is configured to:
output for display the at least one recommended virtual object corresponding to a same part type as the reference virtual object when the recommendation label indicates part type matching; and
output for display the at least one recommended virtual object corresponding to a target style when the recommendation label indicates a construction style of the reference virtual object, the target style including at least one of the construction style or an association style associated with the construction style.

20. A non-transitory computer-readable storage medium storing instructions which, when executed by a processor, cause the processor to perform:
outputting for display a construction interface of a virtual building in a virtual scene, the virtual building including at least one virtual object;
outputting for display at least one recommended virtual object based on a trigger operation performed on a reference virtual object of the at least one virtual object of the virtual building, the at least one recommended virtual object being determined based on a recommendation label of the reference virtual object; and
adding, based on a selection operation performed on a target virtual object of the at least one recommended virtual object, the target virtual object to the virtual building.
